(19) United States
(12) Patent Application Publication
(10) Pub. No.: US 2021/0146169 A1
(43) Pub. Date: May 20, 2021

(54) Respirator with Filter

(71) Applicant: Milwaukee Electric Tool Corporation, Brookfield,, WI (US)

(72) Inventors: Adam M. Moller, Grafton, WI (US); Grant T. Squiers, Cudahy, WI (US); Benjamin T. Jones, St. Francis, WI (US); Nicole Z. Summersett, Milwaukee, WI (US); Aaron M Williams, Milwaukee, WI (US); Michael Stearns, Milwaukee, WI (US)

(73) Assignee: Milwaukee Electric Tool Corporation, Brookfield,, WI (US)

(21) Appl. No.: 17/097,523

(22) Filed: Nov. 13, 2020

Related U.S. Application Data
(60) Provisional application No. 62/935,379, filed on Nov. 14, 2019.

(51) Int. Cl. A62B 7/10; A62B 23/02; A62B 9/04; A62B 18/02; A62B 18/08

(52) U.S. Cl. CPC A62B 7/10; A62B 23/02; A62B 18/025; A62B 18/02; A62B 18/084; A62B 9/04

(57) ABSTRACT

A debris management tool, such as a respirator including a filter is shown. The respirator utilizes a series of straps and connectors that permit the respirator to be pivoted away from a face of a user when not in use.

### CROSS-REFERENCE TO RELATED PATENT APPLICATIONS

This application claims priority to and the benefit of U.S. Provisional Application No. 62/935,379, filed Nov. 14, 2019, which is incorporated herein by reference in its entirety.

### BACKGROUND OF THE INVENTION

The present disclosure is directed generally to the field of debris management, such as at a construction worksite. The present disclosure relates specifically to a respirator with a filter to protect users from breathing particles and dust in the air.

Respirators are often used to protect a user's lungs from particles and dust in the air.

### SUMMARY OF THE INVENTION

One embodiment of the disclosure relates to a respirator that includes a housing and a filter. The user's face and the respirator collectively define a secured area through which most and/or all air entering the secured area must pass through the filter. The filter removes some, most and/or all of the particulates and other harmful elements from entering the secured area, thus helping to protect the user's lungs. In a specific embodiment the top of the filter includes a chamfered edge that extends from the upper surface towards the front of the filter, which is the inlet. The chamfered edge is angled to reduce and/or eliminate interference with the user's sight lines. In a specific embodiment, the angle between the chamfered corner and the upper surface of the filter cartridge is between 15 and 40 degrees, and more specifically is between 20 and 32 degrees, and more specifically is 25 degrees. In a specific embodiment the respirator includes a faceplate.

Another embodiment of the disclosure relates to a respirator that includes a housing and a filter. The user's face and the respirator collectively define a secured area through which most and/or all air entering the secured area must pass through the filter. In a specific embodiment the top of the filter includes a chamfered edge that extends from the upper surface towards the front of the filter, which is the inlet. The chamfered edge is angled to reduce and/or eliminate interference with the user's sight lines. In a specific embodiment, the angle between the chamfered corner and the inlet is between 60 and 85 degrees, and more specifically is between 70 and 75 degrees, and more specifically is 73 degrees. In a specific embodiment the respirator includes a faceplate.

Another embodiment of the disclosure relates to a respirator that includes a housing, a faceplate coupled to the housing, and a filter. The user's face and the respirator collectively define a secured area through which most and/or all air entering the secured area must pass through the filter. In a specific embodiment the top of the filter includes a chamfered edge that extends from the upper surface towards the front of the filter, which is the inlet. The chamfered edge is angled to reduce and/or eliminate interference with the user's sight lines. In a specific embodiment, the chamfered corner defines a plane that extends towards the user's eyes and defines an angle with the faceplate that is between 20 and 45 degrees, and more specifically is between 25 and 35 degrees, and more specifically is 29 degrees.

Another embodiment of the disclosure relates to a respirator that includes a housing and a filter. The user's face and the respirator collectively define a secured area through which most and/or all air entering the secured area must pass through the filter. In a specific embodiment the respirator is secured to the user's head via an upper strap that is coupled to a crown, which rests on the user's head. The upper strap is attached to the respirator housing via a connector, which is selectively detachable from the respirator. When the upper strap connector is detached, the user can pivot the respirator away from the user's face to breath in fresh unfiltered air and/or to take a drink.

Another embodiment of the disclosure relates to a respirator including a body, a filter coupled to the body and configured to remove particulates from air passing through the filter, a gasket coupled to the body, the gasket facilitating a seal between the body and a face of a user, a secured area defined by the gasket, the filter, and the face of the user, a crown configured to rest on a head of the user, a first upper strap coupled to the crown, and a first connector coupled to the first upper strap and detachably coupled to the body. The filter is configured such that most of the air entering the secured area passes through the filter. When the first connector is detached from the body, the respirator is pivotable away from the face of the user.

In a specific embodiment, the crown is a strap having a generally circular shaped inner edge defining a circular open area. In a specific embodiment, the respirator includes an opposing pair of upper straps and upper strap connectors that include the first upper strap and the first upper strap connector. The upper straps and the upper strap connectors couple the body to the crown, and the opposing pairs of upper straps are coupled to opposing sides of the crown.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a perspective view of a respirator, according to an exemplary embodiment.

FIG. 2 is a perspective view of the filter elements of FIG. 1, according to an exemplary embodiment.

FIG. 3 is a perspective view of a respirator, according to an exemplary embodiment.

FIG. 4 is a perspective view of the respirator of FIG. 3, according to an exemplary embodiment.

FIG. 5 is a perspective view of a respirator, according to an exemplary embodiment.

FIG. 6 is a perspective view of the respirator of FIG. 5, according to an exemplary embodiment.

### DETAILED DESCRIPTION

Referring generally to the figures, various embodiments of respirators are shown. Applicant has observed that in various respirators the filter interferes with the sightlines of the user, the filter can be difficult to replace, and the respirator can be cumbersome to remove. One or more of the respirators described herein include filter elements that are designed to reduce and/or eliminate interference with a user's sight lines, such as by including a chamfered upper outer edge of the filter element. This configuration provides better viewability for the user compared to traditional cartridges that have full corners, which intrude the user's line of sight. In another embodiment the respirator includes one or more detachable straps that allow the respirator to be pivoted away from the user's mouth without having to remove the respirator and/or any other equipment the user is wearing (e.g., a hard hat).

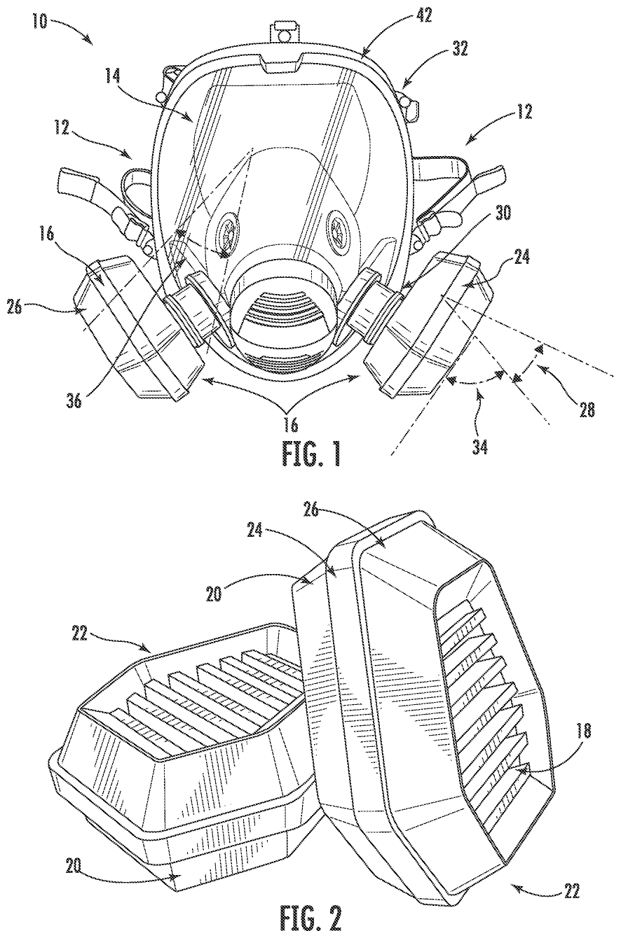

Referring to FIGS. 1-2, a respirator is shown according to an exemplary embodiment. Respirator 10 includes straps 12, which secure respirator 10 to the user's face. In various embodiments respirator 10 includes a face mask, shown as faceplate 14, which is transparent and/or mostly transparent, permitting the user to continue to see and work. Faceplate 14 is coupled to housing 42, which itself is coupled to the user's face via straps 12. When coupled to a user's face, respirator 10 and the user's face collectively define secured area 32. When respirator 10 is used, most and/or all of the air permitted to enter secured area 32 must first pass through a filter, shown as replaceable filter cartridge 16.

Filter cartridge 16 is coupled to housing 42 via connector 30. Filter cartridge 16 provides fluid communication for gasses, such as ambient air, from ambient air to secured area 32. In various embodiments air that passes through filter cartridge 16 also passes through a filter that is internal to filter cartridge 16, and the filter cleans some, most, or even all of the particulates that are present in the air being filtered. Air enters filter cartridge 16 via inlet 18, and exits filter cartridge 16 into secured area 32.

Filter cartridge 16 includes an internal portion 20 and an external portion 22. When coupled to respirator 10, internal portion 20 is closer to the user's face and external portion 22 is facing away from the user's face. Filter cartridge 16 includes a corner surface, shown as chamfered corner 26, which extends between upper surface 24 and inlet 18. In the embodiment shown, chamfered corner 26 is angled to reduce and/or eliminate interference with the user's sight lines.

In a specific embodiment, angle 28 between chamfered corner 26 and upper surface 24 is between 15 and 40 degrees, and more specifically is between 20 and 32 degrees, and more specifically is 25 degrees.

In a specific embodiment, angle 34 between chamfered corner 26 and inlet 18 is between 60 and 85 degrees, and more specifically is between 70 and 75 degrees, and more specifically is 73 degrees.

In a specific embodiment, chamfered corner 26 defines a plane that extends towards user's eyes and defines angle 36 with faceplate 14. Angle 36 is between 20 and 45 degrees, and more specifically is between 25 and 35 degrees, and more specifically is 29 degrees.

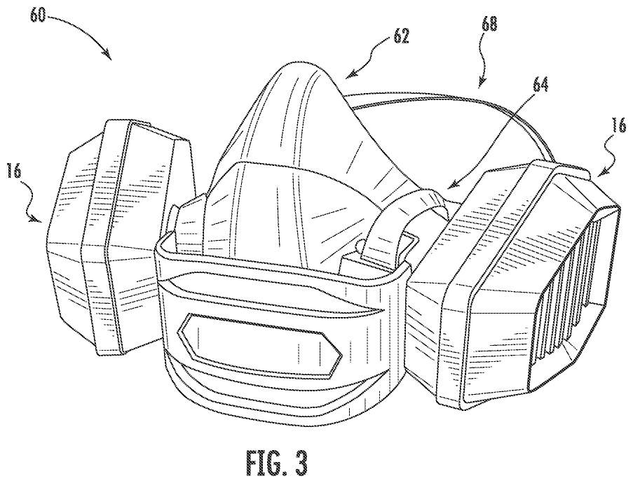

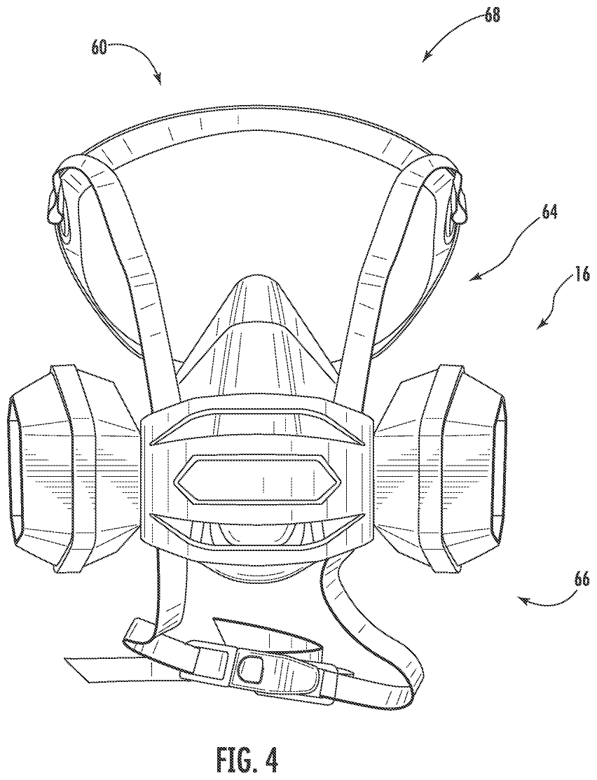

FIGS. 3-4 depict respirator 60. Respirator 60 is substantially the same as respirator 10 except for the differences discussed herein. Respirator 60 includes gasket 62, which facilitate the seal between respirator 60 and the user's face. In various embodiments respirator 10 also includes a gasket to facilitate the seal with the user's face.

Respirator 60 includes upper strap 64, which couples respirator 60 to crown 68. In use, crown 68 rests on a user's head to secure respirator 60. Crown 68 is placed beneath other objects the user is wearing, such as a hard hat. Lower strap 66 secures respirator 60 to user by looping around a lower portion of the user's head/neck area, such as the upper neck and/or the lower head. Lower strap 66 and upper strap 64 collectively secure respirator 60 to a user's face. Similar to respirator 60, filter cartridges 16 filter air transiting filter cartridge 16 towards the secured area between respirator 60 and the user's face.

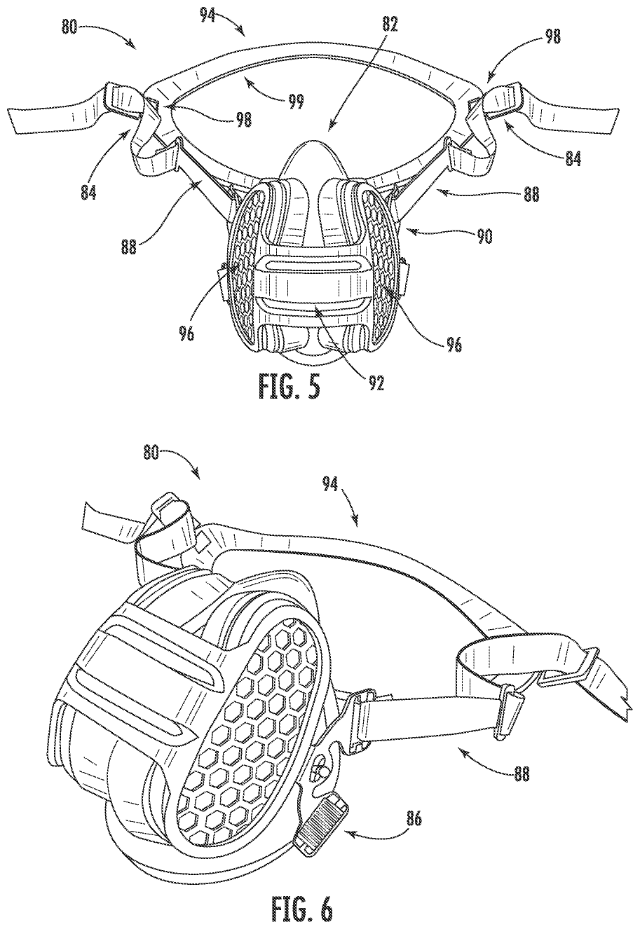

FIGS. 5-6 depict respirator 80. Respirator 80 is substantially the same as respirator 10 and respirator 60 except for the differences discussed herein. Respirator 80 includes body 92, filter element 96, gasket 82, crown 94, upper strap 84 coupled to crown 94, and upper strap connector 88. The filter element 96 is coupled to body 92 and configured to remove particulates from air passing through the filter element 96. Gasket 82 is coupled to body 92 such that gasket 82 facilitates a seal between body 92 and a face of a user. A secured area is defined by gasket 82, filter element 96, and the face of the user, and the filter element 96 is configured such that most of the air entering the secured area passes through the filter element 96.

Crown 94 is configured to rest on a head of the user. Upper strap 84 is coupled to crown 94 and upper strap connector 88. Upper strap 84 couples body 92 to crown 94, and lower strap 86 is coupled to respirator 80 to help secure respirator body 92 to user's head/neck area. To enter the secured area between respirator 80 and the user's face, most and/or all of the air passes through a filter, shown as filter element 96.

Upper strap connector 88 is coupled to upper strap 84 and detachably coupled to body 92, thereby coupling upper strap 84 and crown 94 to body 92. In various embodiments upper strap connector 88 can be decoupled from fastener 90. When upper strap connector 88 is detached from the body 92, body 92 is pivotable away from the face of the user. This permits the user to pivot body 92 away from a user's face without having to first remove other equipment, such as the user's hard hat.

In a specific embodiment, crown 94 is a strap having a generally circular shaped inner edge 99 defining a circular open area (shown FIG. 5). In a specific embodiment, respirator comprises an opposing pair of upper straps 84 and upper strap connectors 88 that couple body 92 to crown 94, and the opposing pairs of upper straps 84 are coupled to opposing sides of crown 94.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

What is claimed is:

1. A respirator comprising:
a body;
a filter coupled to the body and configured to remove particulates from air passing through the filter;
a gasket coupled to the body, the gasket facilitates a seal between the body and a face of a user;
a secured area defined by the gasket, the filter, and the face of the user, wherein the filter is configured such that most of the air entering the secured area passes through the filter;
a crown configured to rest on a head of the user;
a first upper strap coupled to the crown; and
a first connector coupled to the first upper strap and detachably coupled to the body, wherein when the first connector is detached from the body, the respirator is pivotable away from the face of the user.

2. The respirator of claim 1, wherein the crown is a strap having a generally circular shaped inner edge defining a circular open area.

3. The respirator of claim 2, further comprising an opposing pair of upper straps and upper strap connectors that include the first upper strap and the first upper strap connector, wherein the upper straps and the upper strap connectors couple the body to the crown, and wherein the opposing pairs of upper straps are coupled to opposing sides of the crown.
